(19) United States
(12) Patent Application Publication
(10) Pub. No.: US 2023/0028398 A1
(43) Pub. Date: Jan. 26, 2023

(54) INFORMATION PROCESSING DEVICE AND METHOD

(71) Applicant: TOSHIBA TEC KABUSHIKI KAISHA, Tokyo (JP)

(72) Inventor: Hirokazu Matsuno, Numazu Shizuoka (JP)

(21) Appl. No.: 17/715,134

(22) Filed: Apr. 7, 2022

(30) Foreign Application Priority Data
Jul. 21, 2021 (JP) 2021-120911

(51) Int. Cl. G07G 1/00; G07G 1/01; G06Q 20/20

(52) U.S. Cl. CPC G07G 1/0072; G07G 1/01; G06Q 20/208

(57) ABSTRACT

An information processing device includes a first acquisition unit that acquires merchandise identification information identifying a merchandise, expiration date information indicating an expiration date determined for the merchandise, and exhibition unit information indicating a merchandise exhibition unit where the merchandise is exhibited, with respect to merchandises exhibited in the merchandise exhibition unit; a registration unit that registers merchandise exhibition information associated with the merchandise identification information, the expiration date information, and the exhibition unit information acquired by the first acquisition unit; a second acquisition unit that acquires the merchandise identification information and the expiration date information of sold merchandises; and an update unit that updates the merchandise exhibition information based on the merchandise identification information and the expiration date information acquired by the second acquisition unit.

### CROSS-REFERENCE TO RELATED APPLICATION

This application is based upon and claims the benefit of priority from Japanese Patent Application No. 2021-120911, filed on Jul. 21, 2021, the entire contents of which are incorporated herein by reference.

### FIELD

Embodiments described herein relate generally to an information processing device and a method.

### BACKGROUND

In the related art, an expiry date of a merchandise is managed in a store that sells merchandises such as groceries. A transaction supporting device that manages the expiry date of a merchandise and grants a point according to a period until the expiry date of the corresponding merchandise to a customer who purchases a merchandise is suggested (for example, JP-A-2020-107028). The transaction supporting device encourages a customer to purchase a merchandise with a short period until the expiry date and it can be said that the management of the expiry date leads to the reduction of disposal loss.

Meanwhile, in the store, in order to exclude a merchandise that reaches the expiry date or a use-by date from an exhibition unit or in order to put a discount sticker on a merchandise that is near the expiry date, checking exhibited merchandises (hereinafter, referred to as “merchandise checking”) is performed. The merchandise checking is performed by a clerk confirming the expiry date or a use-by date indicated on the packaging or the like of a merchandise with respect to each merchandise exhibited on an exhibition unit and thus a great deal of labor is required. Therefore, it is desired to perform merchandise checking efficiently.

### DESCRIPTION OF THE DRAWINGS

FIG. 1 is a diagram schematically illustrating a merchandise management system including an information processing device according to an embodiment;

FIG. 2 is a block diagram illustrating a hardware configuration of a POS terminal;

FIG. 3 is a block diagram illustrating a functional configuration of the POS terminal;

FIG. 4 is a block diagram illustrating a hardware configuration of a scanner;

FIG. 5 is a block diagram illustrating a functional configuration of the scanner;

FIG. 6 is a block diagram illustrating a hardware configuration of a management server;

FIG. 7 is a diagram illustrating a data configuration of a merchandise master stored in a memory unit of the management server;

FIG. 8 is a diagram illustrating a data configuration of an exhibition unit master stored in the memory unit;

FIG. 9 is a diagram illustrating a data configuration of a merchandise management file stored in the memory unit;

FIG. 10 is a block diagram illustrating a functional configuration of the management server;

FIG. 11 is a sequence chart illustrating a flow of an operation of the merchandise management system;

FIG. 12 is a flowchart illustrating a flow of a registration process by a control unit of the management server;

FIG. 13 is a flowchart illustrating a flow of an update process by the control unit; and

FIG. 14 is a flowchart illustrating a flow of an output process by the control unit.

### DETAILED DESCRIPTION

The transaction supporting device in the related art described above manages the expiry date but the management does not use the merchandise checking performed in the store. Therefore, the transaction supporting device in the related art has a problem that the merchandise checking cannot be performed effectively.

Therefore, an advantage achieved by an exemplary embodiment is to provide an information processing device and a method that can improve the efficiency of merchandise checking for checking an expiration date of a merchandise in an exhibition unit.

In general, according to one embodiment, an information processing device includes a first acquisition unit configured to acquire merchandise identification information identifying a merchandise, expiration date information indicating an expiration date determined for the merchandise, and exhibition unit information indicating a merchandise exhibition unit where the merchandise is exhibited, with respect to merchandises exhibited in the merchandise exhibition unit; a registration unit configured to register merchandise exhibition information associated with the merchandise identification information, the expiration date information, and the exhibition unit information acquired by the first acquisition unit, to a memory unit; a second acquisition unit configured to acquire the merchandise identification information and the expiration date information of sold merchandises; and an update unit configured to update the merchandise exhibition information based on the merchandise identification information and the expiration date information acquired by the second acquisition unit.

Hereinafter, an information processing device and a method according to the embodiment is described with reference to the drawings. In addition, the exemplary embodiment is not limited to an embodiment described below. For example, according to the following embodiment, an example in which an information processing device is employed in a supermarket that sells fresh food or the like is described, but the embodiment is not limited thereto. The information processing device can be widely used in stores that sell merchandises with set expiration dates. Further, in the following embodiment, an example in which expiration date information is set as information indicating an expiry date of a merchandise is described, but the embodiment is not limited thereto. The expiration date information may be information indicating a use-by date of a merchandise, information indicating a sales expiration date of a merchandise that is not limited to groceries but is those with a set sales expiration date, and the like.

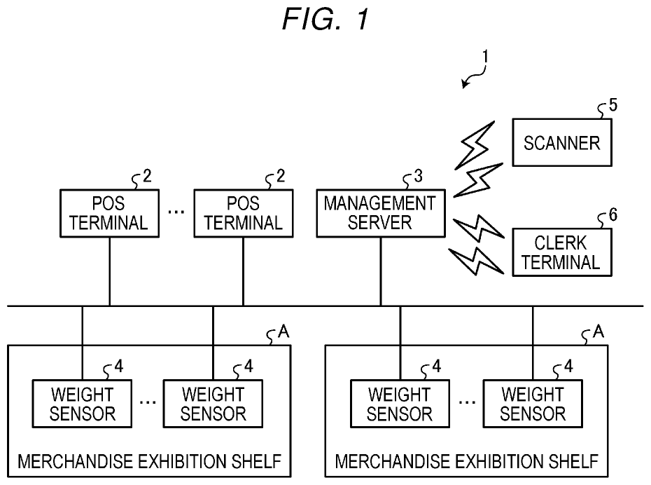

FIG. 1 is a diagram schematically illustrating a merchandise management system including the information processing device. A merchandise management system 1 is employed in a supermarket or the like that sells a merchandise such as fresh food with a set expiry date. The merchandise management system 1 includes a point of sales (POS) terminal 2, a management server 3, a weight sensor 4, a scanner 5, and a clerk terminal 6. The POS terminal 2, the management server 3, the weight sensor 4, the scanner 5, and the clerk terminal 6 are communicably connected to each other via the network such as a local area network (LAN) or a wireless LAN.

A plurality of POS terminals 2 are provided in check-out counters in a store and are operated by clerks. The POS terminal 2 is an example of a payment device that performs a payment process related to payment of a price of a merchandise to be sold. In addition, as a payment device, a payment device with which customers perform operations related to payment processes by themselves, for example, a payment device such as a self-service POS terminal or a semi-self-service POS may be used.

The management server 3 is provided at a back office of a store. The management server 3 receives merchandise information of a merchandise subjected to the payment process and settlement information relating to a settlement method or the like from the POS terminal 2. Further, the management server 3 receives sales information indicating a sales amount from the POS terminal 2. The management server 3 intensively manages received merchandise information, settlement information, sales information, and the like, and performs sales management or the like in one store to function as a sales management device.

In addition, the management server 3 manages expiration date information of merchandises that are in the exhibition unit that exhibits merchandises to be sold or the like based on information acquired from the POS terminal 2, the weight sensor 4, and the scanner 5. According to the present embodiment, the expiration date information is information indicating the expiry date of a merchandise. The management server 3 outputs information to be managed to the corresponding clerk terminal 6 in response to a request from the clerk terminal 6. The management server 3 functions as a merchandise management device that manages the expiry date of a merchandise exhibited in the exhibition unit, and is an example of the information processing device.

The weight sensors 4 are installed on a plurality of merchandise exhibition shelves A that are arranged in the store. The weight sensors 4 are respectively installed in the plurality of exhibition areas that are set in the merchandise exhibition shelf A. The exhibition area is set on a per merchandise basis and a plurality of merchandises with different expiry dates with respect to one kind of merchandise are exhibited in one exhibition area. The exhibition areas set on a per merchandise basis are an example of the merchandise exhibition unit. Hereinafter, the exhibition area may be referred to as a “merchandise exhibition unit”.

The weight sensor 4 is a sensor that detects a weight change of the merchandise exhibition unit and outputs the weight change to the management server 3, and is an example of a sensor provided in the merchandise exhibition unit. In addition, the sensor may detect changes of the merchandise exhibition unit, in other words, changes of the number of merchandises exhibited in the merchandise exhibition unit and may be, for example, a camera that captures an image of the merchandise exhibition unit. A sensor ID for identifying the own device, information indicating detected weight changes (hereinafter, also referred to as “weight change information”), and time information indicating time for detecting the corresponding weight change are associated with each other and, if necessary, output to the management server 3 by the weight sensor 4.

The sensor ID is set in association with the merchandise exhibition unit and can be an example of exhibition unit information indicating the merchandise exhibition unit. The management server 3 calculates a change of the number of the merchandises exhibited in the merchandise exhibition unit based on the weight change output by the weight sensor 4, and the weight change information output by the weight sensor 4 is an example of first quantity information.

The scanner 5 is a handy type scanner, and is used if a clerk exhibits merchandises in the merchandise exhibition unit (hereinafter, also referred to as “merchandise display”). The scanner 5 reads information relating to the merchandise from labels or the like attached to the merchandise during the merchandise display. Specifically, the scanner 5 reads a merchandise code for identifying a merchandise from a barcode printed on the label. The merchandise code is an example of the merchandise identification information.

In addition, the scanner 5 reads expiration date information indicating an expiry date printed on a label or packaging of the merchandise. The expiration date information may be encoded on the barcode together with the merchandise code and may be printed with characters independently from the barcode. The scanner 5 reads expiration date information by a character recognition process such as an optical character reader (OCR) or an image recognition process. The scanner 5 outputs the merchandise code and the expiration date information that are read during the merchandise display to the management server 3 together with time information indicating time when the merchandise code and the expiration date information are read.

In addition, according to the present embodiment, the expiry date is determined to be printed with characters at a predetermined position on the label on which the barcode is printed, for example, above the barcode. The scanner 5 performs a character recognition process on the characters at the predetermined position on the label and reads the expiration date information. In this manner, it is not necessary to cause a barcode to include an expiration date information, and the expiration date information can be read without changing the barcode system used so far.

The clerk terminal 6 is an information terminal including a display machine. The clerk terminal 6 displays information acquired from the management server 3, for example, if a clerk performs merchandise checking for removing a merchandise that reaches an expiry date from the merchandise exhibition unit. The clerk terminal 6 is an example of a display device.

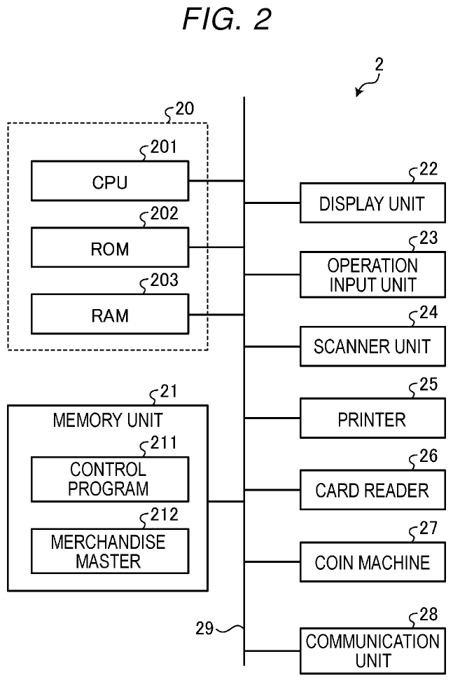

Subsequently, a hardware configuration of the POS terminal 2 is described. FIG. 2 is a block diagram illustrating the hardware configuration of the POS terminal 2. The POS terminal 2 includes a control unit 20, a memory unit 21, a display unit 22, an operation input unit 23, a scanner unit 24, a printer 25, a card reader 26, a coin machine 27, and a communication unit 28. The control unit 20, the memory unit 21, the display unit 22, the operation input unit 23, the scanner unit 24, the printer 25, the card reader 26, the coin machine 27, and the communication unit 28 are communicably connected to each other via a bus 29 or the like.

The control unit 20 is configured with a computer including a central processing unit (CPU) 201, a read only memory (ROM) 202, and a random access memory (RAM) 203. The CPU 201, the ROM 202, and the RAM 203 are connected to each other via the bus 29.

The CPU 201 controls the entire POS terminal 2. The ROM 202 stores various programs such as a program used for driving the CPU 201 or various kinds of data. The RAM 203 is used as a work area of the CPU 201 and loads various programs and various kinds of data stored in the ROM 202 or the memory unit 21. The control unit 20 performs various control processes of the POS terminal 2 by an operation of the CPU 201 according to a control program stored in the ROM 202 or the memory unit 21 and loaded in the RAM 203.

The memory unit 21 is configured with a storage medium such as a hard disk drive (HDD) or a flash memory and maintains the stored contents even if the power supply is cut off. The memory unit 21 stores a control program 211 and a merchandise master 212.

The control program 211 is a control program for an operation as the POS terminal 2. The merchandise master 212 is a master file that stores a merchandise code and merchandise information (such as a merchandise name, a price, or a weight) in correlation with each other, with respect to a merchandise handled in the store. The merchandise master 212 is distributed from the management server 3. Details of the merchandise master 212 are described below.

The display unit 22 displays various kinds of information. For example, if a merchandise purchased by a customer is registered (hereinafter, also referred to as “merchandise registration”), the display unit 22 displays merchandise information of the corresponding merchandise. In addition, if the payment process of merchandises subjected to the merchandise registration is performed, the display unit 22 displays a total price of purchased merchandises.

The operation input unit 23 is operated by an operator who operates the POS terminal 2 and inputs information related to the operation to the control unit 20. The operation input unit 23 inputs, for example, a payment instruction for instructing execution of the payment process to the control unit 20. The operation input unit 23 is configured with a keyboard or a touch panel provided on a surface of the display unit 22.

The scanner unit 24 recognizes a code symbol of a barcode or the like attached to a merchandise purchased by a customer optically or by image capturing. Also, the scanner unit 24 decodes the recognized code symbol and reads a merchandise code indicated by the code symbol. In addition, a code symbol recognized by the scanner unit 24 may be decoded by the control unit 20 of the POS terminal 2. In addition, the scanner unit 24 may include a function that can specify a merchandise by an object recognition method for recognizing the merchandise based on the feature data of the merchandise in appearance such as color and unevenness.

Further, the scanner unit 24 reads expiration date information indicating the expiry date printed on the label. The scanner unit 24 performs the character recognition process on the characters at the predetermined position on the label and reads the expiration date information.

The printer 25 is configured, for example, with a thermal printer. The printer 25 prints information related to a transaction or the like on a roll-shaped receipt paper and dispenses the paper as a receipt from a receipt dispenser (not illustrated).

The card reader 26 magnetically reads credit information necessary for the settlement from a credit card. In addition, the card reader 26 magnetically reads member information for specifying a member from a medium such as a membership card or a point card. In addition, the card reader 26 may be an IC card reader that reads information from an IC card with an integrated circuit (IC) chip incorporated.

If the customer pays the purchase price of the merchandise in cash, the coin machine 27 receives banknotes and coins paid by the customer and dispenses coins, if necessary.

The communication unit 28 is an interface for communication with an external device such as the management server 3. The control unit 20 is connected to the external device via the communication unit 28 and enables transmission and reception of information (data) to and from the corresponding external device.

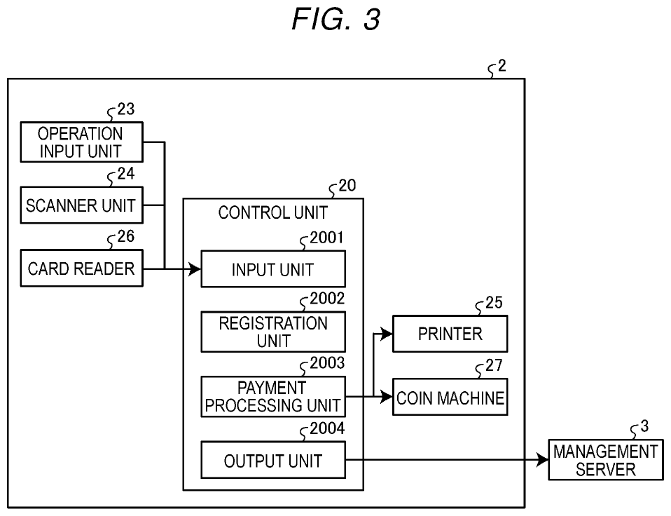

Subsequently, a functional configuration of the POS terminal 2 is described. FIG. 3 is a block diagram illustrating main functional configurations of the control unit 20 of the POS terminal 2. The control unit 20 functions as an input unit 2001, a registration unit 2002, a payment processing unit 2003, and an output unit 2004 by operating the CPU 201 according to the control program stored in the ROM 202 or the memory unit 21. In addition, the functions may be configured with hardware such as a dedicated circuit.

Various kinds of information are input from the operation input unit 23, the scanner unit 24, and the card reader 26 to the input unit 2001. For example, the payment instruction for instructing the execution of the payment process is input from the operation input unit 23 to the input unit 2001. In addition, the merchandise code read by the scanner unit 24 is input from the corresponding scanner unit 24 to the input unit 2001. Further, the credit information read by the card reader 26 is input from the corresponding card reader 26 to the input unit 2001.

The registration unit 2002 performs the merchandise registration on the merchandise purchased by the customer. Specifically, the registration unit 2002 reads merchandise information corresponding to the merchandise code input to the input unit 2001 from the merchandise master 212 and stores the corresponding merchandise code and the corresponding merchandise information in the RAM 203. The merchandise information is information including a merchandise code, a merchandise name, a price, and the like.

The payment processing unit 2003 performs the payment process related to the payment of the price of the merchandise subjected to the merchandise registration by the registration unit 2002. Specifically, the payment processing unit 2003 calculates a total price (transaction price) of the merchandises subjected to the merchandise registration and calculates change amounts or the like. Also, the payment processing unit 2003 instructs the coin machine 27 to dispense coins and also instructs the printer 25 to dispense a receipt. In addition, if the customer desires the cashless settlement such as the credit settlement or the two-dimensional code settlement, the payment processing unit 2003 can perform the payment process necessary for the settlement.

The output unit 2004 outputs various kinds of information to the management server 3. For example, the output unit 2004 outputs merchandise information of the merchandise subjected to the payment process, information relating to the settlement method, information indicating the sales amount, and the like to the management server 3. In addition, a merchandise code of the merchandises purchased by the customer, the expiration date information of the corresponding merchandise, and quantity information indicating a purchased number of corresponding merchandises for one transaction are associated with each other and output to the management server 3 by the output unit 2004. The quantity information output by the POS terminal 2 is an example of second quantity information.

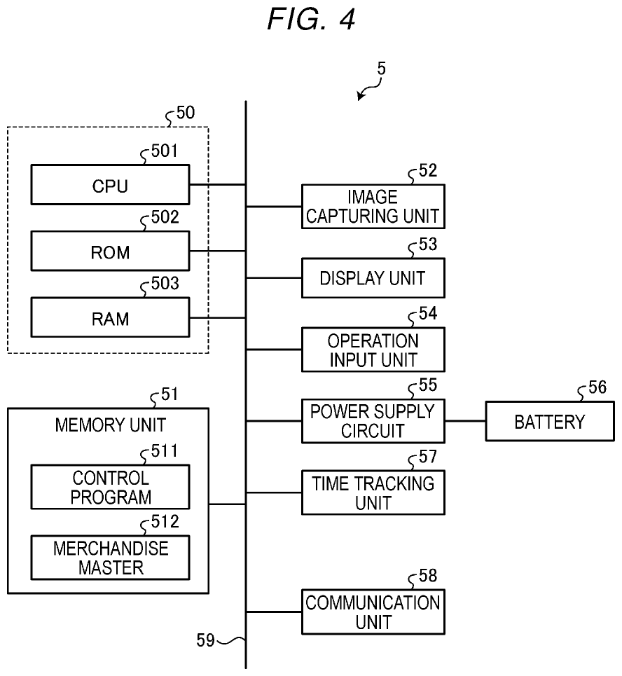

Subsequently, a hardware configuration of the scanner 5 is described. FIG. 4 is a block diagram illustrating the hardware configuration of the scanner 5. The scanner 5 includes a control unit 50, a memory unit 51, an image capturing unit 52, a display unit 53, an operation input unit 54, a power supply circuit 55, a battery 56, a time tracking unit 57, and a communication unit 58. The control unit 50, the memory unit 51, the image capturing unit 52, the display unit 53, the operation input unit 54, the power supply circuit 55, the time tracking unit 57, and the communication unit 58 are communicably connected to each other via a bus 59 or the like.

The control unit 50 is configured with a computer including a CPU 501, a ROM 502, and a RAM 503. The CPU 501, the ROM 502, and the RAM 503 are connected to each other via the bus 59.

The CPU 501 controls the entire scanner 5. The ROM 502 stores various programs such as a program used for driving the CPU 501 or various kinds of data. The RAM 503 is used as a work area of the CPU 501 and loads various programs or various kinds of data stored in the ROM 502 or the memory unit 51. The control unit 50 performs various control processes of the scanner 5 by an operation of the CPU 501 according to a control program stored in the ROM 502 or the memory unit 51 and loaded in the RAM 503.

The memory unit 51 is configured with a storage medium such as an HDD or a flash memory and maintains the stored contents even if the power supply is cut off. The memory unit 51 stores a control program 511 and a merchandise master 512.

The control program 511 is a control program for reading a merchandise code or expiration date information, and the like. The merchandise master 512 is the same as the merchandise master stored in the POS terminal 2 and is acquired from the management server 3. The details of the merchandise master 512 are described below.

The image capturing unit 52 includes image capturing elements such as a charge coupled device (CCD) or a complementary MOS (CMOS) and image capturing lenses. The image capturing unit 52 captures an image of, for example, a barcode attached to the merchandise. In addition, the image capturing unit 52 captures an image of a character indicating an expiry date printed with a character on the label attached to the merchandise or the packaging of the merchandise.

The display unit 53 displays various kinds of information. The display unit 53 displays, for example, a merchandise display start button for inputting the start of the merchandise display or a merchandise display completion button for inputting the completion of the merchandise display. In addition, the display unit 53 displays merchandise information of the merchandise corresponding to the merchandise code read from the barcode of which the image is captured by the image capturing unit 52. The display unit 53 displays the merchandise information read from the merchandise master 512 corresponding to the read merchandise code. Accordingly, the clerk can confirm the merchandises to be subjected to merchandise display.

The operation input unit 54 is configured with a touch panel provided on a surface of the display unit 53 and inputs the information according to a position touched by the user to the control unit 50. For example, the operation input unit 54 inputs start information indicating that the merchandise display starts or completion information indicating that the merchandise display is completed, to the control unit 50.

The power supply circuit 55 is connected to the battery 56. The power supply circuit 55 is a circuit that supplies the electric power to a hardware of the scanner 5. The power supply circuit 55, for example, steps down the voltage supplied from the battery 56 to the operation voltage of the hardware to supply electric power to the corresponding hardware. The battery 56 can be charged by being connected to the commercial power source via a charging device (not illustrated).

The time tracking unit 57 is a tracking device such as a real time clock (RTC) and tracks the present time.

The communication unit 58 is an interface for communication of the management server 3 or the like with an external device. The control unit 50 is connected to the external device via the communication unit 58 so that the information (data) can be transmitted and received to and from the corresponding external device.

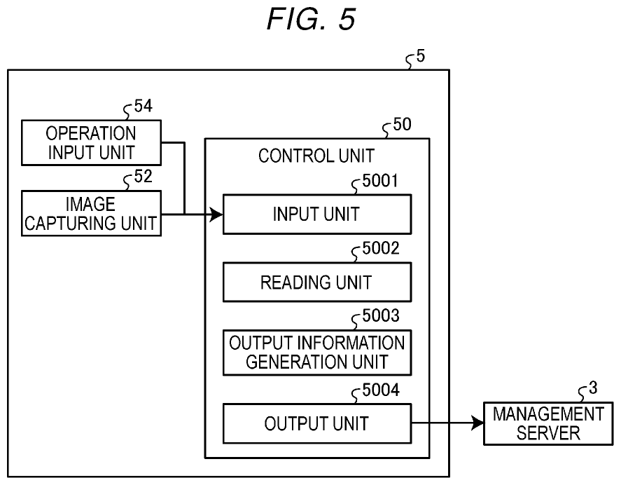

Subsequently, a functional configuration of the scanner 5 is described. FIG. 5 is a block diagram illustrating the main functional configurations of the control unit 50 of the scanner 5. The control unit 50 functions as an input unit 5001, a reading unit 5002, an output information generating unit 5003, and an output unit 5004, by the operation of the CPU 501 according to the control program stored in the ROM 502 or the memory unit 51. In addition, each of the functions may be configured with hardware such as dedicated circuits.

Various kinds of information are input from the image capturing unit 52 and the operation input unit 54 to the input unit 5001. For example, a frame image captured by the image capturing unit 52 is input from the corresponding image capturing unit 52 to the input unit 5001. In addition, quantity information designated on the quantity input screen is input from the operation input unit 54 to the input unit 5001. Further, the start information indicating that the merchandise display starts is input to the input unit 5001.

The reading unit 5002 reads the merchandise code or the expiration date information from the frame image input to the input unit 5001. For example, the reading unit 5002 extracts the barcode from the frame image by the image process and decodes the corresponding barcode to read the merchandise code. In addition, the reading unit 5002 recognizes the label from the frame image and performs the character recognition process on the characters indicating the expiry date presented at the predetermined position on the corresponding label, to read the expiration date information.

The output information generating unit 5003 generates the output information output to the management server 3. For example, the merchandise code and the expiration date information read from the label by the reading unit 5002 are associated with the time information indicating the time when the merchandise code and the expiration date information are read, and the output information generating unit 5003 generates the output information. That is, the output information generated by the output information generating unit 5003 is information that the merchandise code, the expiration date information, and the time information are associated with each other. The time when the reading unit 5002 reads the merchandise code and the expiration date information is tracked by the time tracking unit 57.

The output unit 5004 outputs the output information generated by the output information generating unit 5003 to the management server 3. According to the present embodiment, the management server 3 associates the information output from the scanner 5 and the information output from the weight sensor 4 with the time information as a key, during the merchandise display. Therefore, the output unit 5004 outputs the output information associated with the merchandise code, the expiration date information, and the time information to the management server 3. However, for example, the management server 3 can associate the information output from the scanner 5 and the information output from the weight sensor 4 with the exhibition unit number as a key. In this case, the output unit 5004 outputs the output information associated with the merchandise code, the expiration date information, and the exhibition unit number to the management server 3. The exhibition unit number output by the output unit 5004 may be input, for example, by the operation input unit 54 and may be input by the image capturing unit 52 capturing an image of the exhibition unit number displayed on the merchandise exhibition unit.

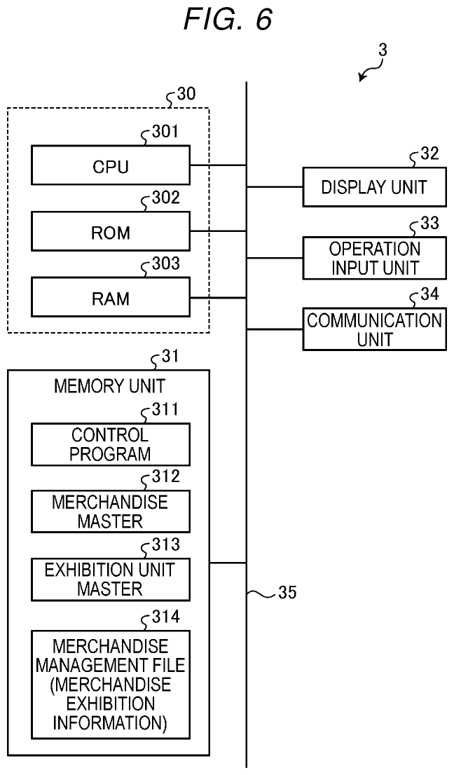

Subsequently, a hardware configuration of the management server 3 is described. FIG. 6 is a block diagram illustrating the hardware configuration of the management server 3. The management server 3 includes a control unit 30, a memory unit 31, a display unit 32, an operation input unit 33, and a communication unit 34. The control unit 30, the memory unit 31, the display unit 32, the operation input unit 33, and the communication unit 34 are connected to each other via a bus 35, or the like.

The control unit 30 is configured with a computer including a CPU 301, a ROM 302, and a RAM 303. The CPU 301, the ROM 302, and the RAM 303 are connected to each other via the bus 35.

The CPU 301 controls the operation of the entire management server 3. The ROM 302 stores various programs such as a program used for driving the CPU 301 or various kinds of data. The RAM 303 is used as a work area of the CPU 301 and loads various programs or various kinds of data stored in the ROM 302 or the memory unit 31. The control unit 30 performs various control processes of the management server 3 by the operation of the CPU 301 according to a control program stored in the ROM 302 or the memory unit 31 and loaded in the RAM 303.

The memory unit 31 is configured with a storage medium such as an HDD or a flash memory and maintains the stored contents even if the power supply is cut off. The memory unit 31 stores a control program 311, a merchandise master 312, an exhibition unit master 313, and a merchandise management file 314.

Examples of the control program 311 include a program for causing the management server 3 to function as a sales management device and a program for causing the management server 3 to function as a merchandise management device.

The merchandise master 312 is a master file that stores information on merchandises handled in the store.

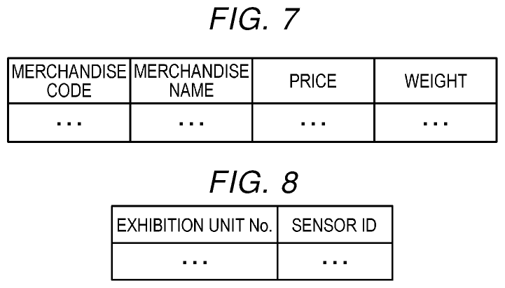

The merchandises handled in the store change every day, and thus the merchandise master 312 is appropriately updated. The management server 3 transmits the updated merchandise master 312 to the POS terminal 2 and the scanner 5. FIG. 7 is a diagram illustrating a data configuration of the merchandise master 312. In the merchandise master 312, each kind of information indicating merchandise codes, merchandise names, prices, and weights is associated.

The merchandise code for identifying a merchandise is registered in the section of the merchandise code. The information indicating the name of the merchandise is registered in the section of the merchandise name. The information indicating a unit price of the merchandise is registered in the section of the price. The unit price may be a pre-tax price or a tax-included price including a consumption tax. The weight information indicating a weight per merchandise is registered in the section of the weight. In addition, if there are individual merchandises with different weights with respect to the same kind of merchandise, a merchandise code can be set for each weight, or a subclassification code for classifying the merchandise code can be provided. In this case, the merchandise code or the subclassification code set for each weight configures merchandise identification information. In other words, if there are merchandises having different weights with respect to the same kind of merchandise, these merchandises can be set as different merchandises.

The exhibition unit master 313 is a master file that stores the relationship between the merchandise exhibition unit and the weight sensor 4. FIG. 8 is a diagram illustrating a data configuration of the exhibition unit master 313. In the exhibition unit master 313, the exhibition unit number and the sensor ID are associated with each other.

Numbers for specifying a plurality of merchandise exhibition units set in the merchandise exhibition shelf A are registered in the section of the exhibition unit number. The exhibition unit number is an example of the exhibition unit information. Sensor IDs for identifying the weight sensors 4 are registered in the section of the sensor ID. As described above, the sensor ID is also an example of the exhibition unit information.

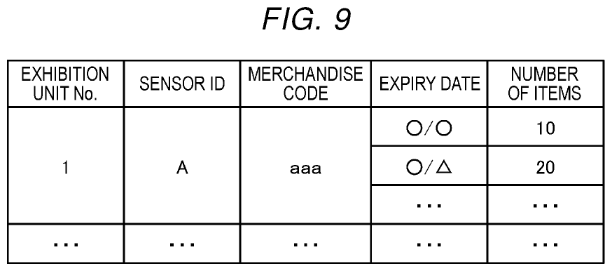

The merchandise management file 314 is a file that manages expiry dates of the merchandises exhibited in the merchandise exhibition unit. The merchandise management file 314 is updated based on the information acquired from the POS terminal 2, the weight sensor 4, the scanner 5, and the like by the management server 3. FIG. 9 is a diagram illustrating a data configuration of the merchandise management file 314. In the merchandise management file 314, each kind of information indicating exhibition unit numbers, sensor IDs, merchandise codes, expiry dates, and quantities is registered. The merchandise management file 314 is an example of merchandise exhibition information associated with the merchandise identification information, the expiration date information, and the exhibition unit information.

Numbers for specifying the plurality of merchandise exhibition units set in the merchandise exhibition shelf A are registered in the section of the exhibition unit number.

Sensor IDs for identifying the weight sensors 4 are registered in the section of the sensor ID. Merchandise codes for identifying the merchandises are registered in the section of the merchandise code. Expiration date information indicating expiry dates of the merchandises are registered in the section of the expiry date. A plurality of pieces of expiration date information are set with respect to one merchandise code. In the section of the quantity, the information indicating the number of merchandises exhibited in the merchandise exhibition unit is registered corresponding to each expiry date. The information registered in the section of the quantity is an example of exhibition quantity information.

Referring back to FIG. 6, the hardware of the management server 3 is described. The display unit 32 displays various kinds of information. The display unit 32 displays, for example, various operation screens, the contents of the merchandise management file 314, and the like.

The operation input unit 33 is configured with a keyboard or the like. The operation input unit 33 inputs merchandise information to the control unit 30, for example, if the merchandise master is updated.

The communication unit 34 is an interface for communication with an external device such as the POS terminal 2, the weight sensor 4, the scanner 5, and the clerk terminal 6. The control unit 30 is connected to the external device via the communication unit 34 to enable transmission and reception of the information (data) to and from the corresponding external device.

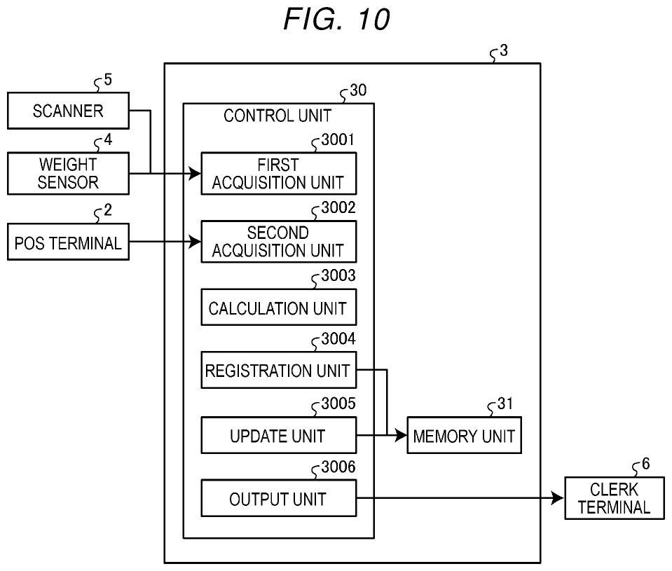

Subsequently, a functional configuration of the control unit 30 of the management server 3 is described. FIG. 10 is a block diagram illustrating the main functional configurations of the control unit 30 of the management server 3. The control unit 30 functions as a first acquisition unit 3001, a second acquisition unit 3002, a calculation unit 3003, a registration unit 3004, an update unit 3005, and an output unit 3006 by the operation of the CPU 301 according to the control program stored in the ROM 302 or the memory unit 31. In addition, each of the functions may be configured with hardware such as dedicated circuits.

The first acquisition unit 3001 acquires the merchandise identification information for identifying the corresponding merchandise, the expiration date information indicating the expiration date determined for the corresponding merchandise, and the exhibition unit information indicating the merchandise exhibition unit where the corresponding merchandise is exhibited, with respect to the merchandise exhibited in the merchandise exhibition unit. Specifically, the first acquisition unit 3001 acquires the merchandise code and the expiration date information from the scanner 5 and also acquires the sensor ID from the weight sensor 4.

More specifically, the first acquisition unit 3001 acquires, from the scanner 5, time information indicating the time when the corresponding merchandise code and the expiration date information are read in association with the merchandise code and the expiration date information. In addition, the first acquisition unit 3001 acquires, from the weight sensor 4, the time information indicating the time when the weight change information (first quantity information) and the weight change are detected in association with the sensor ID.

In addition, the first acquisition unit 3001 may acquire the merchandise identification information, the expiration date information, and the exhibition unit information by inputting the information to the operation input unit 33. For example, so-called “shelf allocation” that determines which merchandise is exhibited in which merchandise exhibition unit is set in advance, so that the information determined in the corresponding shelf allocation may be input to the operation input unit 33 before the merchandise is exhibited in the merchandise exhibition unit. However, as in the present embodiment, since the first acquisition unit 3001 acquires the information from the weight sensor 4 and the scanner 5 during the merchandise display, the store does not need to generate shelf allocation before the merchandise display and does not need to input the information to the operation input unit 33, and thus the work efficiency during the merchandise display can be improved.

The second acquisition unit 3002 acquires the merchandise identification information and the expiration date information of the sold merchandises. Specifically, the second acquisition unit 3002 acquires the merchandise code and the expiration date information of the merchandises purchased by the customer, from the POS terminal 2. More specifically, the second acquisition unit 3002 acquires the second quantity information indicating the number of merchandises purchased by the customer in addition to the merchandise code and the expiration date information from the POS terminal 2.

The calculation unit 3003 calculates the number of merchandises exhibited in the merchandise exhibition unit based on the weight change information acquired from the weight sensor 4 by the first acquisition unit 3001. Specifically, the calculation unit 3003 calculates the number of the merchandises exhibited in the merchandise exhibition unit during the merchandise display as below. Also, the calculation unit 3003 calculates the number of merchandises exhibited in the merchandise exhibition unit based on the number of recognized merchandises before the merchandise display and the number of merchandises subjected to the merchandise display.

First, the calculation unit 3003 calculates the weight change in the merchandise exhibition unit during the predetermined time from the weight change information acquired by the first acquisition unit 3001. The predetermined time is the time since start information indicating the start of the merchandise display of one merchandise is input from the scanner 5 to the management server 3 until the completion information indicating the completion of the merchandise display of the corresponding one merchandise is input to the management server 3. The management server 3 can recognize the merchandise subjected to the merchandise display based on the merchandise code that the first acquisition unit 3001 acquires from the scanner 5 following the start information. Subsequently, the calculation unit 3003 refers to the merchandise master 312 and reads the weight information corresponding to the merchandise code acquired by the first acquisition unit 3001. The calculation unit 3003 calculates the number of the merchandises subjected to the merchandise display based on the weight change during the predetermined time and the weight information indicating the weight per merchandise.

The registration unit 3004 registers (stores) the merchandise exhibition information associated with the merchandise identification information, the expiration date information, and the exhibition unit information acquired by the first acquisition unit 3001 to the memory unit 31. Specifically, the merchandise code and the expiration date information acquired from the scanner 5 by the first acquisition unit 3001 and the sensor ID acquired from the weight sensor 4 that detects the weight change are associated with each other and stored in the merchandise management file 314 by the registration unit 3004.

The association between the merchandise code and the expiration date information and the sensor ID is performed based on the time information acquired from the scanner 5 and the weight sensor 4 by the first acquisition unit 3001. The registration unit 3004 specifies the weight sensor 4 that transmits, for example, the time information indicating the time after the reading time indicated by the time information acquired from the scanner 5 by the first acquisition unit 3001, that is, the time information indicating the time within the set time set in advance from the corresponding reading time to the management server 3. Also, the registration unit 3004 associates the sensor ID acquired from the specified weight sensor 4, with the merchandise code and the expiration date information acquired from the scanner 5. With respect to the merchandise display, the merchandise of which the merchandise code and the expiration date information are read by the scanner 5 is immediately placed in the merchandise exhibition unit, and thus the sensor ID is associated with the merchandise code and the expiration date information as described above.

If the merchandise display is performed in a state in which the merchandise is present in the merchandise exhibition unit, in other words, if the merchandise display is performed in a state in which various kinds of information are stored in the merchandise management file 314, the registration unit 3004 updates the merchandise management file 314 based on the information from the weight sensor 4 and the scanner 5. That is, the registration by the registration unit 3004 is a concept including at least one of the generation or the update of the merchandise management file 314. In addition, the registration unit 3004 registers the number of merchandises subjected to the merchandise display, which is calculated by the calculation unit 3003, to the merchandise management file 314.

The update unit 3005 updates the merchandise exhibition information based on the merchandise identification information and the expiration date information acquired by the second acquisition unit 3002. Specifically, the update unit 3005 updates the merchandise management file 314 based on the merchandise code and the expiration date information acquired from the POS terminal 2 by the second acquisition unit 3002. In addition, the update unit 3005 updates the merchandise management file 314 based on the second quantity information acquired by the second acquisition unit 3002.

The output unit 3006 outputs the merchandise exhibition information updated by the update unit 3005 to the display device. Specifically, the output unit 3006 outputs information for indicating the contents of the merchandise management file 314 to the corresponding clerk terminal 6 in response to an output request from the clerk terminal 6. In other words, the merchandise exhibition information output by the output unit 3006 may be the merchandise management file 314 stored in the memory unit 31, and may be a form different from the merchandise management file 314.

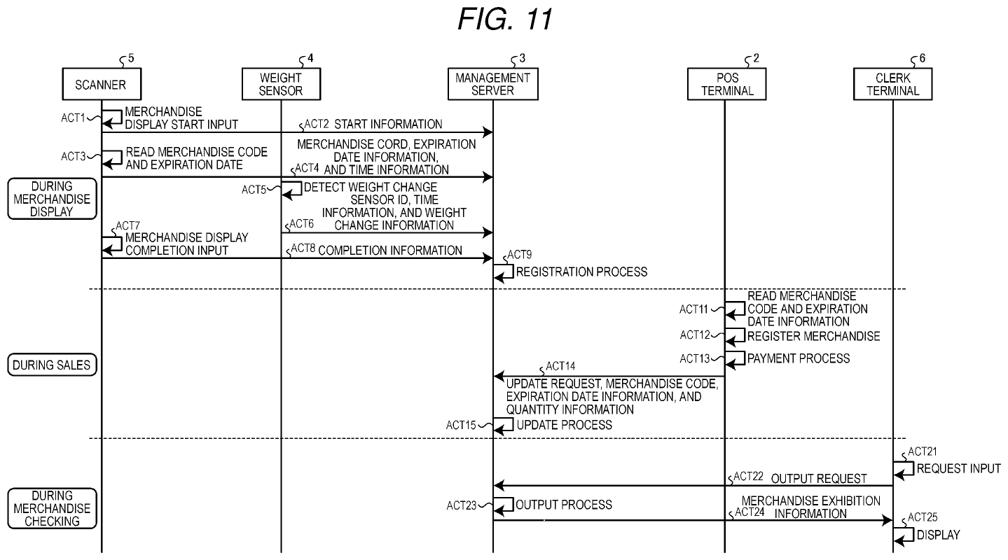

Subsequently, the outline of the operations during the merchandise display, during the sales, and during the merchandise checking by the merchandise management system 1 is described. FIG. 11 is a sequence chart illustrating a flow of an operation of the merchandise management system 1.

First, the operation during the merchandise display is described. In addition, a case where a plurality of merchandises with the same expiry date with respect to one kind of the merchandise are subjected to the merchandise display is described. In other words, a case where a set of the same merchandises with the same expiry dates (hereinafter, referred to as a “lot merchandise”) is subjected to the merchandise display is described.

In case of performing the merchandise display, the clerk prepares the lot merchandises and the scanner 5 and goes to the merchandise exhibition shelf A. The clerk operates the operation input unit 54 of the scanner 5 to perform the merchandise display start input for instructing the start of the merchandise display with respect to the lot merchandises (ACT 1). The scanner 5 transmits the start information indicating that the merchandise display starts with respect to the lot merchandises to the management server 3 (ACT 2).

Next, with respect to the first merchandise of the lot merchandises, the scanner 5 reads the merchandise code and the expiration date information from the label of the merchandise by an operation of the clerk (ACT 3). The reading may be performed once with respect to the lot merchandises. The scanner 5 transmits the read merchandise code and the read expiration date information to the management server 3 in association with the time information indicating the time when the merchandise code and the expiration date information are read (ACT 4).

If the merchandise of which the merchandise code and the expiration date information are read is placed in the merchandise exhibition unit, the weight sensor 4 detects the weight change (ACT 5). The weight sensor 4 transmits the weight change information indicating the detected weight change to management server 3 in association with the sensor ID of the own device and the time information indicating the time when the weight change is detected (ACT 6). With respect to the second and subsequent merchandises, the merchandise code and the expiration date information are not read, and the merchandises are sequentially placed in the merchandise exhibition unit. In addition, the weight sensor 4 transmits weight change information whenever a weight change is detected or at regular time intervals.

If the merchandise display is completed with respect to the lot merchandises, an input instructing the scanner 5 to complete the merchandise display is performed by the operation of the clerk (ACT 7). The scanner 5 transmits the completion information indicating that the merchandise display is completed to the management server 3 (ACT 8). If the completion information is received, the management server 3 performs a registration process based on the information received from the scanner 5 and the weight sensor 4 between the reception of the start information and the reception of the completion information (ACT 9). The registration process is a process of storing various kinds of information in the merchandise management file 314, and details thereof are described below. If other lot merchandises are subjected to the merchandise display, the processes from ACT 1 to ACT 9 are repeatedly performed.

Next, the operation during the sales is described. If the customer brings the purchased merchandises to the POS terminal 2, the POS terminal 2 reads the merchandise codes and the expiration date information of the corresponding merchandises by the operation of the clerk (ACT 11). The POS terminal 2 performs the merchandise registration based on the read merchandise codes (ACT 12). If the merchandise registration for all of the merchandises purchased by the customer for one transaction is completed, the POS terminal 2 performs payment process (ACT 13).

The POS terminal 2 transmits the merchandise codes, the expiration date information, and the quantity information of the merchandises purchased by the customer to the management server 3 together with the update request of the merchandise management file 314 (ACT 14). The management server 3 performs an update process based on the information received from the POS terminal 2 (ACT 15). The update process is a process for updating various kinds of information registered in the merchandise management file 314, and details thereof are described below.

According to the operations during the merchandise display and the sales of the merchandise management system 1, the merchandise management file 314 of the management server 3 is registered and updated. Accordingly, the management server 3 can manage the number of merchandises exhibited in the merchandise exhibition unit for each expiry date.

Subsequently, the operation during the merchandise checking is described. The clerk performs the merchandise checking for excluding the merchandises that reach the expiry dates from the merchandise exhibition unit, for example, once a day. In addition, the merchandise checking is performed in a case of putting a discount sticker on a merchandise close to the expiry date.

The clerk possesses the clerk terminal 6 and goes to the merchandise exhibition shelf A when performing the merchandise checking. The clerk operates the clerk terminal 6 to perform the request input for requesting the merchandise exhibition information from the management server 3 (ACT 21). The clerk terminal 6 transmits the output request of the merchandise exhibition information to the management server 3 (ACT 22).

If the output request is received, the management server 3 performs an output process (ACT 23). The output process is a process for outputting the merchandise exhibition information for browsing the contents managed by the merchandise management file 314 with the clerk terminal 6, and the details thereof are described below. The management server 3 transmits the merchandise exhibition information to the clerk terminal 6 based on the output process (ACT 24). The clerk terminal 6 displays based on the received merchandise exhibition information (ACT 25).

The clerk who performs the merchandise checking can browse the information relating to the expiry dates of the merchandises exhibited in the merchandise exhibition unit with the clerk terminal 6. Accordingly, the clerk can easily recognize whether there is a merchandise that reaches the expiry date in the merchandise exhibition unit, that is, a merchandise to be excluded from the merchandise exhibition unit. Therefore, for example, an operation of visually confirming the expiry dates of the merchandises exhibited in the corresponding merchandise exhibition unit becomes unnecessary even though there is no merchandise to be excluded from the merchandise exhibition unit, and thus the efficiency of the operation of the merchandise checking is improved.

In addition, if there is a merchandise to be excluded in the merchandise exhibition unit, the clerk who performs the merchandise checking can recognize how many merchandises are to be excluded. Therefore, if the expiry dates are visually confirmed for the number of the merchandises to be excluded and the merchandises are excluded from the merchandise exhibition unit, the expiry dates of the remaining merchandises do not need to be confirmed. From this point as well, the efficiency of the operation of the merchandise checking is improved.

Subsequently, the registration process, the update process, and the output process performed by the control unit 30 of the management server 3 are described.

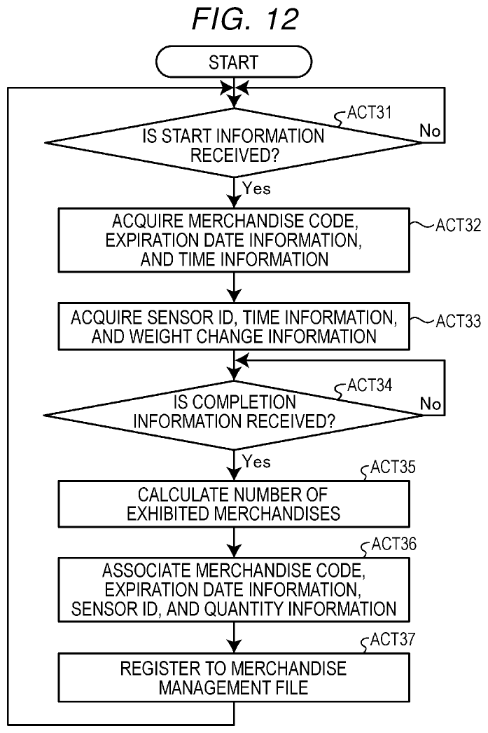

First, the registration process is described. FIG. 12 is a flowchart illustrating a flow of a registration process by the control unit 30 of the management server 3.

The control unit 30 determines whether the start information is received from the scanner 5 (ACT 31). If the start information is not received (No in ACT 31), the control unit 30 returns to the process of ACT 31 and stands by. If the start information is received (Yes in ACT 31), the first acquisition unit 3001 acquires the merchandise code, the expiration date information, and the time information associated with each other, from the scanner 5 (ACT 32). The merchandise codes, the expiration date information, and the time information are received from the scanner 5 after the start information, so that the first acquisition unit 3001 acquires the information.

In addition, the first acquisition unit 3001 may acquire the merchandise codes, the expiration date information, and the time information that are input by the operation input unit 33 and stored in the RAM 303, from the corresponding RAM 303. In this case, before the merchandise display, the clerk operates the operation input unit 33, so that the merchandise codes, the expiration date information, and the time information relating to the merchandises to be subjected to the merchandise display are associated with each other and stored in the RAM 303.

Subsequently, the first acquisition unit 3001 acquires the sensor ID, the time information, and the weight change information associated with each other, from the weight sensor 4 (ACT 33). After start information is received, the weight change information indicating weight changes detected by the weight sensor 4, the sensor IDs, and time information are received from the weight sensor 4, so that the first acquisition unit 3001 acquires the information.

Next, the control unit 30 determines whether the completion information is received from the scanner 5 (ACT 34). If the completion information is not received (No in ACT 34), the control unit 30 returns to the process of ACT 34 and stands by. If the control unit 30 receives the completion information (Yes in ACT 34), the calculation unit 3003 calculates the number of merchandises exhibited in the merchandise exhibition unit by the merchandise display (ACT 35).

The merchandise codes, the expiration date information, the sensor IDs, and the quantity information are associated with each other by the registration unit 3004 (ACT 36). The merchandise codes and the expiration date information acquired from the scanner 5 by the first acquisition unit 3001, the sensor IDs acquired from the weight sensor 4, and the number of merchandises calculated by the calculation unit 3003, that is, the number of merchandises exhibited in the merchandise exhibition unit by the merchandise display are associated with each other by the registration unit 3004. The registration unit 3004 registers the associated information in ACT 36 to the merchandise management file 314 (ACT 37). Also, the control unit 30 returns to the process of ACT 31 and stands by until the start information of the merchandise display of the next lot merchandise is received.

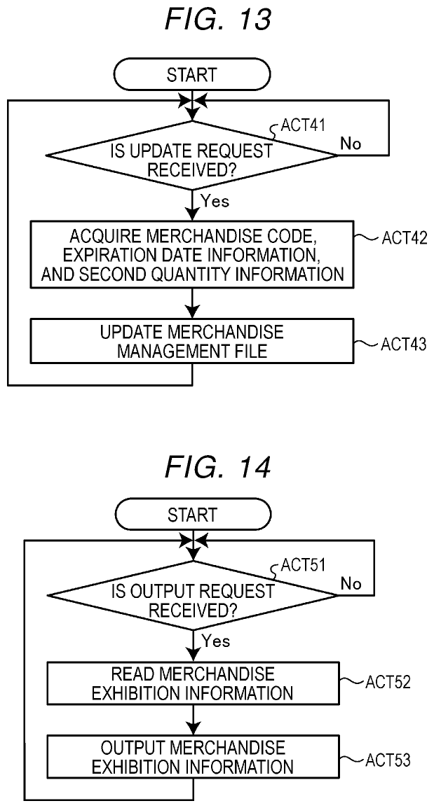

Subsequently, the update process is described. FIG. 13 is a flowchart illustrating a flow of the update process by the control unit 30 of the management server 3.

The control unit 30 determines whether the update request is received from the POS terminal 2 (ACT 41). If the update request is not received (No in ACT 41), the control unit 30 returns to the process of ACT 41 and stands by. If the update request is received (Yes in ACT 41), the second acquisition unit 3002 acquires the merchandise codes, the expiration date information, and the second quantity information associated with each other from the POS terminal 2 (ACT 42). The merchandise codes, the expiration date information, and the quantity information are received from the POS terminal 2 after the update request, so that the second acquisition unit 3002 acquires the information.

The update unit 3005 updates the merchandise management file 314 based on the information acquired by the second acquisition unit 3002 (ACT 43). Also, the control unit 30 returns to the process of ACT 41 and stands by until the next update request is received.

Subsequently, the output process is described. FIG. 14 is a flowchart illustrating a flow of the output process by the control unit 30 of the management server 3.

The control unit 30 determines whether the output request is received from the clerk terminal 6 (ACT 51). If the output request is not received (No in ACT 51), the control unit 30 returns to the process of ACT 51 and stands by. If the output request is received (Yes in ACT 51), the control unit 30 reads the merchandise exhibition information for indicating the contents of the merchandise management file 314 from the memory unit 31 (ACT 52), and outputs the merchandise exhibition information to the clerk terminal 6 (ACT 53). Accordingly, the clerk terminal 6 can display the contents of the merchandise management file 314. Also, the control unit 30 returns to the process of ACT 51 and stands by until the next output request is received.

As described above, the information processing device (the management server 3) according to the embodiment includes the first acquisition unit 3001 that acquires the merchandise identification information for identifying the corresponding merchandise, the expiration date information indicating the expiration date determined for the corresponding merchandise, the exhibition unit information indicating the merchandise exhibition unit where the corresponding merchandise is exhibited, with respect to the merchandise exhibited in the merchandise exhibition unit; the registration unit 3004 that registers the merchandise exhibition information associated with the merchandise identification information, the expiration date information, and the exhibition unit information acquired by the first acquisition unit 3001, to the memory unit 31; the second acquisition unit 3002 that acquires the merchandise identification information and the expiration date information of the sold merchandises; and the update unit 3005 that updates the merchandise exhibition information based on the merchandise identification information and the expiration date information acquired by the second acquisition unit 3002.

Accordingly, the management server 3 can manage the merchandise exhibition information associated with the merchandise exhibition unit and the expiration date information of the merchandises exhibited in the corresponding merchandise exhibition unit. Therefore, the clerk who performs the merchandise checking can easily confirm whether there is a merchandise to be excluded in the merchandise exhibition unit. Therefore, the management server 3 can improve the efficiency of the merchandise checking.

In addition, in the management server 3 according to the embodiment, the first acquisition unit 3001 acquires the merchandise identification information, the expiration date information, and the time information related to the time when the corresponding scanner 5 reads the information, from the scanner 5 that reads the information indicated by the label attached to the merchandise, and also acquires the exhibition unit information and the time information related to the time when the corresponding sensor detects the change of the merchandise exhibition unit from the sensor (the weight sensor 4) provided in the merchandise exhibition unit, and the merchandise identification information, the expiration date information, and the exhibition unit information are associated with each other by the registration unit 3004 based on the time information acquired from the scanner 5 and the time information acquired from the weight sensor 4.

Accordingly, the information to be acquired from the weight sensor 4 and the information to be acquired from the scanner 5 can be associated with each other by the management server 3 by using the time information. Therefore, the store can easily register the merchandise exhibition information during the merchandise display.

Further in the management server 3 according to the embodiment, the second acquisition unit 3002 acquires the merchandise identification information and the expiration date information from the payment device (the POS terminal 2) that performs the payment process related to the payment of the price of the sold merchandise.

Accordingly, the management server 3 can use the information on the POS terminal 2 and update the sold merchandise exhibition information. Therefore, the store can easily update the merchandise exhibition information.

In addition, in the management server 3 according to the embodiment, the first acquisition unit 3001 acquires the information indicating the number of merchandises exhibited in the merchandise exhibition unit, that is, the first quantity information associated with the merchandise identification information and the expiration date information, the second acquisition unit 3002 acquires the information indicating the number of sold merchandises, that is, the second quantity information associated with the merchandise identification information and the expiration date information, and the merchandise exhibition information is set based on the first quantity information and the second quantity information, and includes the exhibition quantity information associated with the merchandise identification information and the expiration date information.

Accordingly, the management server 3 can manage the merchandise exhibition information including the number of merchandises for each expiration date of the merchandise exhibited in the merchandise exhibition unit. Therefore, the clerk who performs the merchandise checking can recognize the number of merchandises to be excluded from the merchandise exhibition unit. Accordingly, the management server 3 can effectively perform the merchandise checking.

In addition, the management server 3 according to the embodiment further includes the output unit 3006 that outputs the merchandise exhibition information updated by the update unit 3005 to the display device (the clerk terminal 6).

Accordingly, the management server 3 enables, for example, the clerk who performs the merchandise display operation on the merchandise exhibition unit to browse the merchandise exhibition information. From this point, the management server 3 can more effectively perform merchandise checking.

In addition, according to the embodiment, the control program executed by the management server 3 may be configured to be recorded and provided on a computer-readable recording medium such as CD-ROM. In addition, the control program that is executed by the management server 3 according to the embodiment may be configured to be stored in a computer connected to the network such as the Internet and provided by being downloaded via the network and further may be configured by being provided via the network such as the Internet.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
a first acquisition component configured to acquire merchandise identification information identifying a merchandise, expiration date information indicating an expiration date determined for the merchandise, and exhibition component information indicating a merchandise exhibition component where the merchandise is exhibited, with respect to merchandises exhibited in the merchandise exhibition component;
a registration component configured to register merchandise exhibition information associated with the merchandise identification information, the expiration date information, and the exhibition component information acquired by the first acquisition component, to a memory component;
a second acquisition component configured to acquire the merchandise identification information and the expiration date information of sold merchandises; and
an update component configured to update the merchandise exhibition information based on the merchandise identification information and the expiration date information acquired by the second acquisition component.

2. The information processing device according to claim 1,
wherein the first acquisition component acquires the merchandise identification information, the expiration date information, and time information related to time when a scanner reads the information, from the scanner that reads information indicated by a label attached to the merchandise, and acquires the exhibition component information and time information related to time when a sensor detects a change of the merchandise exhibition component from the sensor provided in the merchandise exhibition component, and
the merchandise identification information, the expiration date information, and the exhibition component information are associated with each other by the registration component, based on the time information acquired from the scanner and the time information acquired from the sensor.

3. The information processing device according to claim 1,
wherein the second acquisition component acquires the merchandise identification information and the expiration date information of the sold merchandises from a payment device that performs a payment process related to payment of prices of the merchandises.

4. The information processing device according to claim 1,
wherein the first acquisition component acquires information indicating a number of merchandises exhibited in the merchandise exhibition component including first quantity information associated with the merchandise identification information and the expiration date information,
the second acquisition component acquires information indicating a number of sold merchandises including second quantity information associated with the merchandise identification information and the expiration date information, and
the merchandise exhibition information is set based on the first quantity information and the second quantity information and includes exhibition quantity information associated with the merchandise identification information and the expiration date information.

5. The information processing device according to claim 1, further comprising:
an output component configured to output the merchandise exhibition information updated by the update component to a display device.

6. The information processing device according to claim 1,
wherein the exhibition component information is generated by a weight sensor.

7. The information processing device according to claim 4,
wherein the first quantity information comprises weight change information and the merchandise identification information comprises a merchandise code.

8. A method causing a computer controlling an information processing device, to perform functions comprising:
acquiring merchandise identification information identifying a merchandise, expiration date information indicating an expiration date determined for the merchandise, and exhibition component information indicating a merchandise exhibition component where the merchandise is exhibited, with respect to merchandises exhibited in the merchandise exhibition component;
registering merchandise exhibition information associated with the merchandise identification information, the expiration date information, and the exhibition component information acquired to a memory component;
acquiring the merchandise identification information and the expiration date information of sold merchandises; and
updating the merchandise exhibition information based on the merchandise identification information and the expiration date information acquired.

9. The method according to claim 8, further comprising:
acquiring the merchandise identification information, the expiration date information, and time information related to time when a scanner reads the information, from the scanner that reads information indicated by a label attached to the merchandise, and acquiring the exhibition component information and time information related to time when a sensor detects a change of the merchandise exhibition component from the sensor provided in the merchandise exhibition component, and
wherein the merchandise identification information, the expiration date information, and the exhibition component information are associated with each other by the registration component, based on the time information acquired from the scanner and the time information acquired from the sensor.

10. The method according to claim 8, further comprising:
acquiring the merchandise identification information and the expiration date information of the sold merchandises from a payment device that performs a payment process related to payment of prices of the merchandises.

11. The method according to claim 8, further comprising:
acquiring information indicating a number of merchandises exhibited in the merchandise exhibition component including first quantity information associated with the merchandise identification information and the expiration date information;
acquiring information indicating a number of sold merchandises including second quantity information associated with the merchandise identification information and the expiration date information; and
setting the merchandise exhibition information based on the first quantity information and the second quantity information and including exhibition quantity information associated with the merchandise identification information and the expiration date information.

12. The method according to claim 8, further comprising:
outputting the merchandise exhibition information updated by the update component to a display device.

13. The method according to claim 8, further comprising:
generating the exhibition component information by a weight sensor.

14. A merchandise management system, comprising:
a plurality of POS terminals;
a first acquisition component configured to acquire merchandise identification information identifying a merchandise, expiration date information indicating an expiration date determined for the merchandise, and exhibition component information indicating a merchandise exhibition component where the merchandise is exhibited, with respect to merchandises exhibited in the merchandise exhibition component;
a registration component configured to register merchandise exhibition information associated with the merchandise identification information, the expiration date information, and the exhibition component information acquired by the first acquisition component, to a memory component;
a second acquisition component configured to acquire the merchandise identification information and the expiration date information of sold merchandises; and
an update component configured to update the merchandise exhibition information based on the merchandise identification information and the expiration date information acquired by the second acquisition component.

15. The merchandise management system according to claim 14,
wherein the first acquisition component acquires the merchandise identification information, the expiration date information, and time information related to time when a scanner reads the information, from the scanner that reads information indicated by a label attached to the merchandise, and acquires the exhibition component information and time information related to time when a sensor detects a change of the merchandise exhibition component from the sensor provided in the merchandise exhibition component, and
the merchandise identification information, the expiration date information, and the exhibition component information are associated with each other by the registration component, based on the time information acquired from the scanner and the time information acquired from the sensor.

16. The merchandise management system according to claim 14,
wherein the second acquisition component acquires the merchandise identification information and the expiration date information of the sold merchandises from a payment device that performs a payment process related to payment of prices of the merchandises.

17. The merchandise management system according to claim 14,
wherein the first acquisition component acquires information indicating a number of merchandises exhibited in the merchandise exhibition component including first quantity information associated with the merchandise identification information and the expiration date information,
the second acquisition component acquires information indicating a number of sold merchandises including second quantity information associated with the merchandise identification information and the expiration date information, and
the merchandise exhibition information is set based on the first quantity information and the second quantity information and includes exhibition quantity information associated with the merchandise identification information and the expiration date information.

18. The merchandise management system according to claim 14, further comprising:
an output component configured to output the merchandise exhibition information updated by the update component to a display device.

19. The merchandise management system according to claim 14,
wherein the exhibition component information is generated by a weight sensor.

20. The merchandise management system according to claim 17,
wherein the first quantity information comprises weight change information and the merchandise identification information comprises a merchandise code.
